(19) United States
(12) Patent Application Publication
(10) Pub. No.: US 2017/0367032 A1
(43) Pub. Date: Dec. 21, 2017

(54) Method and Apparatus for Reporting and Processing Proximity Service Capability Information

(71) Applicant: ZTE CORPORATION, Shenzhen City, Guangdong Province (CN)

(72) Inventors: Wei LUO, Shenzhen (CN); Yuqin CHEN, Shenzhen (CN); Lin CHEN, Shenzhen (CN); Zhongda DU, Shenzhen (CN)

(21) Appl. No.: 15/329,253

(22) PCT Filed: Sep. 26, 2014
(86) PCT No.: PCT/CN2014/087611

§ 371 Date: Jun. 13, 2017

(30) Foreign Application Priority Data
Aug. 8, 2014 (CN) 201410390140.4

(51) Int. Cl. H04W 48/08; H04W 72/04; H04W 48/16; H04W 76/02; H04W 4/02

(52) U.S. Cl. CPC H04W 48/08; H04W 76/02; H04W 4/023; H04W 48/16; H04W 72/0453

(57) ABSTRACT

The present document discloses methods and apparatuses for reporting and processing information about a proximity service supporting capability. In the method, a first communication node determines indication information to be reported, herein the indication information is used for indicating information about a proximity service supporting capability of the first communication node, and the first communication node reports the indication information to a second communication node. According to the technical scheme provided by the present document, a base station can more reasonably and effectively allocate service resources to UE.

### TECHNICAL FIELD

The present document relates to the field of communication, in particular to methods and apparatuses for reporting and processing information about a proximity service supporting capability.

### BACKGROUND

With the rapid development of wireless multimedia services, on one hand, the demands of people for high data rate and user experience gradually increase and thereby higher requirements are attached to system capacity and coverage of traditional cellular networks. On the other hand, application scenarios such as public security, social network, short-range data share and local advertisement enable the demands of people for Proximity Services (ProSe for short) for understanding people or things nearby and communicating therewith to gradually increase. The traditional cellular networks which take base stations as centers are obviously limited in aspects of high data rate and proximity service supporting. Under such demand background, a ProSe technology which represents a new development direction of communication in future emerges at the right moment. The application of the ProSe technology can reduce the burden of the cellular networks, decrease battery power consumption of user equipment, improve data rate, effectively improve the robustness of network infrastructure and very well satisfy the requirements on high data rate and proximity services.

The ProSe technology can work at licensed bands or unlicensed bands and allow a plurality of user equipment supporting a ProSe function to perform direct discovery/direct communication under a situation that there is network infrastructure or there is no network infrastructure, herein the user equipment supporting the ProSe function are also called as ProSe User Equipment (ProSe UE for short).

The ProSe technology usually can include a ProSe discovery technology and a ProSe communication technology, herein the ProSe discovery technology refers to a technology which is used for judging/determining that two or more ProSe user equipment are mutually proximate, e.g., in a range that ProSe direct communication can be performed, or which is used for judging/determining that first user equipment is proximate to second user equipment. Under normal situations, the ProSe user equipment can discover each other by transmitting or receiving discovery signals/information. Under a situation that there is cellular network coverage, networks can assist the ProSe user equipment to perform ProSe discovery. The ProSe communication technology refers to a technology that partial or all communication data between the ProSe user equipment can be directly communicated without relying on network infrastructure.

UE which supports the ProSe discovery technology and the ProSe communication technology may be simultaneously in cellular communication and ProSe communication states, or may be simultaneously in cellular communication and ProSe discovery signal transmitting/monitoring states, i.e., while the UE and a base station are kept in cellular communication, data of a ProSe broadcasting service further need to be monitored and a discovery signal needs to be transmitted or transmitting signals transmitted by other UE need to be monitored. In a ProSe communication process, two UE which perform ProSe communication are called as a ProSe UE pair, and each UE can be called ProSe opposite-end UE relative to the other UE. In a ProSe discovery process, UE which transmits a discovery signal is called as transmitting UE or declaration UE, and UE which receives the discovery signal is called as receiving UE or monitoring UE.

Since ProSe services are not unified in the whole network in a network deployment process, a situation that frequencies in partial areas support ProSe services but frequencies in adjacent areas do not support ProSe service. And similarly, not all UE can support a ProSe communication/discovery function, for example, under a situation that some neighboring cells support ProSe services and some neighboring cells do not support ProSe services, an effect that cells which support ProSe are preferably selected for UE which support ProSe services and UE which do not support ProSe services do not need to consider whether switched cells support ProSe cannot be realized in a switching process.

In addition, when a ProSe terminal is in a monitoring state, if a base station does not know that the terminal is monitoring ProSe services, ProSe monitoring services may be interfered when the base station schedules terminal unicast resources. In addition, in the existing technology, the problem of how UE specifically report information about whether proximity services are supported is not solved. Since the above-mentioned problem exists in the related technology, the base station needs to know whether the UE has a ProSe supporting capability.

### SUMMARY

The present document provides methods and apparatuses for reporting and processing information about a proximity service supporting capability, so as to at least solve the problem that a base station cannot know whether a UE has a ProSe capability in the related technology.

According to one aspect of the present document, a method for reporting information about a proximity service supporting capability is provided.

The method for reporting the information about the proximity service supporting capability according to an embodiment of the present document includes: a first communication node determining indication information to be reported, herein the indication information is used for indicating information about a proximity service supporting capability of the first communication node; and the first communication node reporting the indication information to a second communication node.

In an exemplary embodiment, the information about the proximity service supporting capability includes at least one of the following: indication information about supporting a proximity service; indication information about supporting proximity service receiving and/or transmitting; indication information about all bands which correspond to all indicated bands and on which receiving and/or transmitting proximity services is supported; indication information about uplink bands which correspond to all indicated bands and on which receiving and/or transmitting proximity services is supported; indication information about downlink bands which correspond to all indicated bands and on which receiving and/or transmitting proximity services is supported; indication information about all bands which correspond to specially indicated bands and on which receiving and/or transmitting proximity services is supported; indication information about uplink bands which correspond to specially indicated bands and on which receiving and/or transmitting proximity services is supported; indication information about downlink bands which correspond to specially indicated bands and on which receiving and/or transmitting proximity services is supported; indication information about a parameter combination consisting of a band parameter set of bands for cellular communication and a band parameter set of bands for proximity services, in which the cellular communication and the proximity services are supported to be performed simultaneously; band class information of bands supporting proximity services; a band parameter set of bands on which simultaneous reception of cellular communication and proximity services is supported; a band parameter set of bands on which receiving and/or transmitting proximity services is supported; indication information about having a receiver dedicated for supporting a proximity service; indication information about having a transmitter dedicated for supporting a proximity service; indication information about the number of all receiving links; indication information about the number of all transmitting links; indication information about the number of receiving links supporting proximity services; indication information about the number of transmitting links supporting proximity services; indication information about whether gaps are required when proximity services are received on indicated bands; and indication information about whether proximity services are capable of being received simultaneously or in parallel on indicated bands. Herein, the proximity service comprise at least one of the following: a ProSe discovery and a ProSe communication; the uplink band is a uplink frequency configured in a system to which the first communication node is connected or in which the first communication node resides currently; the downlink band is a downlink frequency configured in a system to which the first communication node is connected or in which the first communication node resides currently; and the system comprises at least one of the following: Evolved Universal Terrestrial Radio Access, EUTRA, and Universal Terrestrial Radio Access, UTRA.

In an exemplary embodiment, before the first communication node determines the indication information, the method further includes: the first communication node pre-configuring with the second communication node to complete a corresponding relationship between all band ranges supported by the first communication node and band index value combinations, herein in the corresponding relationship each band range respectively corresponds to a band index value.

In an exemplary embodiment, the first communication node determining the indication information includes one of the following: the first communication node determining that a first index value combination and a second index value combination need to be reported to the second communication node under a situation that the first communication node supports simultaneously receiving and transmitting EUTRA network data in a band range corresponding to the first index value combination and receiving and transmitting proximity service data in a band range corresponding to the second index value combination, wherein each of the first index value combination and the second index value combination comprises one or more index values, and each index value in the one or more index values is respectively carried in a band parameter information unit; and the first communication node determining that a first index value combination or a second index value combination needs to be reported to the second communication node under a situation that the first communication node does not support simultaneously receiving and transmitting EUTRA network data in a band range corresponding to the first index value combination and receiving and transmitting proximity service data in a band range corresponding to the second index value combination, wherein each of the first index value combination and the second index value combination comprises one or more index values, and each index value in the one or more index values is respectively carried in a band parameter information unit.

In an exemplary embodiment, before the first communication node determines the indication information, the method further includes: the first communication node pre-configuring with the second communication node to complete a corresponding relationship between all proximity service band ranges supported by a receiver and/or transmitter dedicated for a proximity service and band index values, herein in the corresponding relationship each proximity service band range respectively corresponds to a band index value, and the proximity service comprises at least one of the following: a ProSe discovery and a ProSe communication.

In an exemplary embodiment, the first communication node determining the indication information includes at least one of the following: the first communication node determining that indication information about having the receiver and/or transmitter dedicated for the proximity service needs to be reported to the second communication node under a situation that the first communication node configures with the receiver and/or transmitter dedicated for the proximity service; and the first communication node determining that the plurality of index value combinations needs to be reported to the second communication node under a situation that the first communication node acquires index values corresponding to various bands from the corresponding relationship when the receiver and/or transmitter dedicated for the proximity service configured by the first communication node works at a plurality of bands.

In an exemplary embodiment, the first communication node reporting the indication information to the second communication node includes at least one of the following: the first communication node reporting the indication information to the second communication node after receiving a request message from the second communication node, wherein the request message is used for acquiring the information about the proximity service supporting capability; and the first communication node reporting actively the indication information to the second communication node.

According to another aspect of the present document, a method for processing information about a proximity service supporting capability is provided.

The method for processing the information about the proximity service supporting capability according to an embodiment of the present document includes: a second communication node receiving indication information reported by a first communication node, herein the indication information is used for indicating information about a proximity service supporting capability of the first communication node; and the second communication node allocating a proximity service resource and/or a cellular network service resource to the first communication node according to the indication information.

In an exemplary embodiment, the information about the proximity service supporting capability includes at least one of the following: indication information about supporting a proximity service; indication information about supporting proximity service receiving and/or transmitting; indication information about all bands which correspond to all indicated bands and on which receiving and/or transmitting proximity services is supported; indication information about uplink bands which correspond to all indicated bands and on which receiving and/or transmitting proximity services is supported; indication information about downlink bands which correspond to all indicated bands and on which receiving and/or transmitting proximity services is supported; indication information about all bands which correspond to specially indicated bands and on which receiving and/or transmitting proximity services is supported; indication information about uplink bands which correspond to specially indicated bands and on which receiving and/or transmitting proximity services is supported; indication information about downlink bands which correspond to specially indicated bands and on which receiving and/or transmitting proximity services is supported; indication information about a parameter combination consisting of a band parameter set of bands for cellular communication and a band parameter set of bands for proximity services, in which the cellular communication and the proximity services are supported to be performed simultaneously; band class information of bands supporting proximity services; a band parameter set of bands on which simultaneous reception of cellular communication and proximity services is supported; a band parameter set of bands on which receiving and/or transmitting proximity services is supported; indication information about having a receiver dedicated for supporting a proximity service; indication information about having a transmitter dedicated for supporting a proximity service; indication information about the number of all receiving links; indication information about the number of all transmitting links; indication information about the number of receiving links supporting proximity services; indication information about the number of transmitting links supporting proximity services; indication information about whether gaps are required when proximity services are received on indicated bands; and indication information about whether proximity services are capable of being received simultaneously or in parallel on indicated bands. Herein, the proximity service comprise at least one of the following: a ProSe discovery and a ProSe communication; the uplink band is a uplink frequency configured in a system to which the first communication node is connected or in which the first communication node resides currently; the downlink band is a downlink frequency configured in a system to which the first communication node is connected or in which the first communication node resides currently; and the system comprises at least one of the following: Evolved Universal Terrestrial Radio Access, EUTRA, and Universal Terrestrial Radio Access, UTRA.

In an exemplary embodiment, the second communication node allocating the proximity service resource and/or the cellular network service resource to the first communication node according to the indication information includes: the second communication node determining that the first communication node has the proximity service supporting capability but does not support receiving and transmitting service data simultaneously in a plurality of band ranges according to the indication information; and the second communication node allocating the proximity service resource and the cellular network service resource to the first communication node through a time-division multiplexing mode; or the second communication node allocating a ProSe discovery resource and the cellular network service resource to the first communication node only through the time-division multiplexing mode.

In an exemplary embodiment, the second communication node allocating the proximity service resource and/or the cellular network service resource to the first communication node according to the indication information includes: the second communication node determining that the first communication node has the proximity service supporting capability and supports simultaneously receiving and transmitting service data in a plurality of band ranges according to the indication information; and the second communication node allocating the proximity service resource and the cellular network service resource to the first communication node through a time-division multiplexing mode; or the second communication node allocating the proximity service resource and the cellular network service resource to the first communication node through a frequency-division multiplexing mode; or the second communication node allocating a ProSe discovery resource and the cellular network service resource to the first communication node through the time-division multiplexing mode and allocating a ProSe communication resource and the cellular network service resource to the first communication node through the frequency-division multiplexing mode.

In an exemplary embodiment, the second communication node receiving the indication information reported by the first communication node includes one of the following: the second communication node receiving the indication information reported by the first communication node after transmitting a request message to the first communication node, wherein the request message is used for acquiring the information about the proximity service supporting capability; and the second communication node receiving the indication information actively reported by the first communication node.

According to another aspect of the present document, an apparatus for reporting information about a proximity service supporting capability is provided.

The apparatus for reporting the information about the proximity service supporting capability according to an embodiment of the present document includes the following modules. A determination module is arranged to determine indication information to be reported, wherein the indication information is used for indicating information about a proximity service supporting capability of the first communication node. A reporting module is arranged to report the indication information to a second communication node.

In an exemplary embodiment, the information about the proximity service supporting capability includes at least one of the following: indication information about supporting a proximity service; indication information about supporting proximity service receiving and/or transmitting; indication information about all bands which correspond to all indicated bands and on which receiving and/or transmitting proximity services is supported; indication information about uplink bands which correspond to all indicated bands and on which receiving and/or transmitting proximity services is supported; indication information about downlink bands which correspond to all indicated bands and on which receiving and/or transmitting proximity services is supported; indication information about all bands which correspond to specially indicated bands and on which receiving and/or transmitting proximity services is supported; indication information about uplink bands which correspond to specially indicated bands and on which receiving and/or transmitting proximity services is supported; indication information about downlink bands which correspond to specially indicated bands and on which receiving and/or transmitting proximity services is supported; indication information about a parameter combination consisting of a band parameter set of bands for cellular communication and a band parameter set of bands for proximity services, in which the cellular communication and the proximity services are supported to be performed simultaneously; band class information of bands supporting proximity services; a band parameter set of bands on which simultaneous reception of cellular communication and proximity services is supported; a band parameter set of bands on which receiving and/or transmitting proximity services is supported; indication information about having a receiver dedicated for supporting a proximity service; indication information about having a transmitter dedicated for supporting a proximity service; indication information about the number of all receiving links; indication information about the number of all transmitting links; indication information about the number of receiving links supporting proximity services; indication information about the number of transmitting links supporting proximity services; indication information about whether gaps are required when proximity services are received on indicated bands; and indication information about whether proximity services are capable of being received simultaneously or in parallel on indicated bands. Herein, the proximity service comprise at least one of the following: a ProSe discovery and a ProSe communication; the uplink band is a uplink frequency configured in a system to which the first communication node is connected or in which the first communication node resides currently; the downlink band is a downlink frequency configured in a system to which the first communication node is connected or in which the first communication node resides currently; and the system comprises at least one of the following: Evolved Universal Terrestrial Radio Access, EUTRA, and Universal Terrestrial Radio Access, UTRA.

In an exemplary embodiment, the above-mentioned apparatus further includes: a first configuration module, which is arranged to pre-configure with the second communication node to complete a corresponding relationship between all band ranges supported by the first communication node and band index value combinations, wherein in the corresponding relationship each band range respectively corresponds to a band index value.

In an exemplary embodiment, the determination module is arranged to determine the indication information according to one of the following: determining that a first index value combination and a second index value combination need to be reported to the second communication node under a situation of simultaneously supporting receiving and transmitting EUTRA network data in a band range corresponding to the first index value combination and receiving and transmitting proximity service data in a band range corresponding to the second index value combination, wherein each of the first index value combination and the second index value combination comprises one or more index values, and each index value in the one or more index values is respectively carried in a band parameter information unit; and determining that a first index value combination or a second index value combination needs to be reported to the second communication node under a situation of not supporting simultaneously receiving and transmitting EUTRA network data in a band range corresponding to the first index value combination and receiving and transmitting proximity service data in a band range corresponding to the second index value combination, wherein each of the first index value combination and the second index value combination comprises one or more index values, and each index value in the one or more index values is respectively carried in a band parameter information unit.

In an exemplary embodiment, the above-mentioned apparatus further includes: a second configuration module, which is arranged to pre-configure with the second communication node to complete a corresponding relationship between all proximity service band ranges supported by a receiver and/or transmitter dedicated for a proximity service and band index values, wherein in the corresponding relationship each proximity service band range respectively corresponds to a band index value, and the proximity service comprises at least one of the following: a ProSe discovery and a ProSe communication.

In an exemplary embodiment, the determination module is arranged to determine the indication information according to one of the following: determining that indication information about having the receiver and/or transmitter dedicated for the proximity service needs to be reported to the second communication node under a situation of configuring with the receiver and/or transmitter dedicated for the proximity service by the first communication node; and determining that the plurality of index value combinations needs to be reported to the second communication node under a situation of acquiring index values corresponding to various bands from the corresponding relationship when the receiver and/or transmitter dedicated for the proximity service configured by the first communication node works at a plurality of bands.

In an exemplary embodiment, the reporting module is arranged to report the indication information to the second communication node according to one of the following: the first communication node reporting the indication information to the second communication node after receiving a request message from the second communication node, wherein the request message is used for acquiring the information about the proximity service supporting capability; and the first communication node reporting actively the indication information to the second communication node.

According to another aspect of the present document, an apparatus for processing information about a proximity service supporting capability is provided.

The apparatus for processing the information about the proximity service supporting capability according to an embodiment of the present document includes the following modules. A receiving module is arranged to receive indication information reported by a first communication node, herein the indication information is used for indicating information about a proximity service supporting capability of the first communication node. An allocation module is arranged to allocate a proximity service resource and/or a cellular network service resource to the first communication node according to the indication information.

In an exemplary embodiment, the information about the proximity service supporting capability includes at least one of the following: indication information about supporting a proximity service; indication information about supporting proximity service receiving and/or transmitting; indication information about all bands which correspond to all indicated bands and on which receiving and/or transmitting proximity services is supported; indication information about uplink bands which correspond to all indicated bands and on which receiving and/or transmitting proximity services is supported; indication information about downlink bands which correspond to all indicated bands and on which receiving and/or transmitting proximity services is supported; indication information about all bands which correspond to specially indicated bands and on which receiving and/or transmitting proximity services is supported; indication information about uplink bands which correspond to specially indicated bands and on which receiving and/or transmitting proximity services is supported; indication information about downlink bands which correspond to specially indicated bands and on which receiving and/or transmitting proximity services is supported; indication information about a parameter combination consisting of a band parameter set of bands for cellular communication and a band parameter set of bands for proximity services, in which the cellular communication and the proximity services are supported to be performed simultaneously; band class information of bands supporting proximity services; a band parameter set of bands on which simultaneous reception of cellular communication and proximity services is supported; a band parameter set of bands on which receiving and/or transmitting proximity services is supported; indication information about having a receiver dedicated for supporting a proximity service; indication information about having a transmitter dedicated for supporting a proximity service; indication information about the number of all receiving links; indication information about the number of all transmitting links; indication information about the number of receiving links supporting proximity services; indication information about the number of transmitting links supporting proximity services; indication information about whether gaps are required when proximity services are received on indicated bands; and indication information about whether proximity services are capable of being received simultaneously or in parallel on indicated bands. Herein, the proximity service comprise at least one of the following: a ProSe discovery and a ProSe communication; the uplink band is a uplink frequency configured in a system to which the first communication node is connected or in which the first communication node resides currently; the downlink band is a downlink frequency configured in a system to which the first communication node is connected or in which the first communication node resides currently; and the system comprises at least one of the following: Evolved Universal Terrestrial Radio Access, EUTRA, and Universal Terrestrial Radio Access, UTRA.

In an exemplary embodiment, the allocation module includes the following units. A first determination unit is arranged to determine that the first communication node has the proximity service supporting capability but does not support receiving and transmitting service data simultaneously in a plurality of band ranges according to the indication information. A first allocation unit is arranged to allocate the proximity service resource and the cellular network service resource to the first communication node through a time-division multiplexing mode; or allocate a ProSe discovery resource and the cellular network service resource to the first communication node only through the time-division multiplexing mode.

In an exemplary embodiment, the allocation module includes the following units. A second determination unit is arranged to determine that the first communication node has the proximity service supporting capability and supports simultaneously receiving and transmitting service data in a plurality of band ranges according to the indication information. A second allocation unit is arranged to allocate the proximity service resource and the cellular network service resource to the first communication node through a time-division multiplexing mode; or allocate the proximity service resource and the cellular network service resource to the first communication node through a frequency-division multiplexing mode; or allocate a ProSe discovery resource and the cellular network service resource to the first communication node through the time-division multiplexing mode and allocate a ProSe communication resource and the cellular network service resource to the first communication node through the frequency-division multiplexing mode.

In an exemplary example, the receiving module is arranged to receive the indication information reported by the first communication node according to one of the following: the second communication node receiving the indication information reported by the first communication node after transmitting a request message to the first communication node, wherein the request message is used for acquiring the information about the proximity service supporting capability; and the second communication node receiving the indication information actively reported by the first communication node.

Through the embodiments of the present document, the following method is adapted: a first communication node determining indication information to be reported, herein the indication information is used for indicating information about a proximity service supporting capability of the first communication node; and the first communication node reporting the indication information to a second communication node. Thus, the problem that a base station cannot know whether a UE has a ProSe capability in the related technology is solved. Thereby, it is achieved that the first communication node can implement reporting of the ProSe capability with smaller overhead, and the second communication node can reasonably and effectively allocate ProSe service and/or cellular network service resources to the first communication node, so that the interference and influence between ProSe services and cellular network services are minimized.

### BRIEF DESCRIPTION OF DRAWINGS

The drawings described here are used for providing further understanding about the present document and constitutes a part of the present application. The exemplary embodiments of the present document and the descriptions thereof are used for explaining the present document instead of improperly limiting the present document. In the drawings:

FIG. 1 illustrates a flowchart of a method for reporting information about a proximity service supporting capability according to an embodiment of the present document

FIG. 2 illustrates a flowchart of a method for processing information about a proximity service supporting capability according to an embodiment of the present document

FIG. 3 illustrates a structural diagram of an apparatus for reporting information about a proximity service supporting capability according to an embodiment of the present document.

FIG. 4 illustrates a structural diagram of an apparatus for reporting information about a proximity service supporting capability according to an alternative embodiment of the present document.

FIG. 5 illustrates a structural diagram of an apparatus for processing information about a proximity service supporting capability according to an embodiment of the present document.

FIG. 6 illustrates a structural diagram of an apparatus for processing information about a proximity service supporting capability according to an alternative embodiment of the present document.

### DETAILED DESCRIPTION

The present document will be described below in detail with reference to the drawings in combination with the embodiments. It shall be illustrated that the embodiments in the present application and the features in the embodiments may be mutually combined under the situation of no conflict.

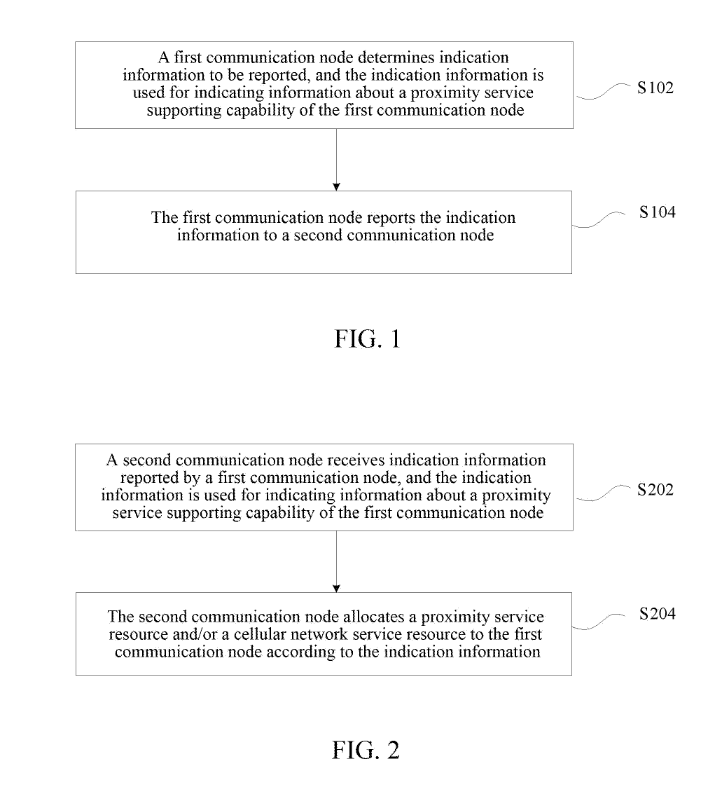

FIG. 1 illustrates a flowchart of a method for reporting information about a proximity service supporting capability according to one embodiment of the present document. As illustrated in FIG. 1, the method may include the following processing steps:

In step S102, a first communication node determines indication information to be reported; herein the indication information is used for indicating information about a proximity service supporting capability of the first communication node.

In step S104, the first communication node reports the indication information to a second communication node.

In the related technology, between two modes, i.e., cellular communication and ProSe/Sidelink communication/discovery modes, due to limitation of UE half-duplex capability and in consideration of interference, UE cannot simultaneously receive and transmit ProSe service data on the same frequency, and cannot receive ProSe service data and transmit cellular network data on the same frequency, either. If it is needed to transmit ProSe service and cellular service data on the same frequency, transmission can only be performed through a time-division multiplexing mode, i.e., UE which performs ProSe service communication divide subframes into special subframes for ProSe communication/discovery service transmission and subframes for cellular network service transmission. On one hand, in consideration of a scenario that ProSe services and cellular services are on the same band which includes an uplink band resource and a downlink band resource, if it is needed to realize an effect of receiving ProSe service data on the uplink band of the same band and receiving cellular network data on the downlink band of the same band, the receiving capability of UE is specially required. If UE has such capability, a base station does not necessarily perform time-division processing for receiving ProSe service data when downlink cellular resources are allocated. Otherwise, the time-division multiplexing mode needs to be considered. If the base station does not know whether UE has a capability of simultaneously receiving ProSe service data and cellular service data, the base station can only perform uniform processing. If UE does not have the capability of simultaneously receiving ProSe service data and cellular service data but the base station does not adopt the time-division multiplexing mode to allocate two types of resources to UE, there is a very great interference between the two types of services. Contrarily, if UE has the capability of simultaneously receiving ProSe service data and cellular service data but the base station still adopts the time-division multiplexing mode to allocate two types of resources to UE, the resources are greatly wasted. If UE does not have a ProSe service communication capability, there are not special subframes for ProSe communication/discovery service transmission. On a premise that no conflict is caused to resources allocated to other UE, cellular network unicast service resources can be allocated on any subframe. Since UE which has the ProSe service communication capability but does not have the capability of simultaneously receiving ProSe service data and cellar service data cannot allocate cellular services on a special subframe for ProSe communication/discovery services, other UE may allocate cellular services on such subframe. If the base station does not know whether UE has the ProSe service communication capability, a correct judgment cannot be made when resources are allocated. On the other hand, in consideration of a scenario that ProSe services and cellular services are on different bands, if UE supports simultaneously receiving and transmitting on two bands, when UE starts ProSe communication transmission, ProSe data need to be received and transmitted on one band and cellular network unicast network data can only be received and transmitted on the other band, i.e., for a cellular network unicast network, the carrier aggregation capability of UE is decreased. If the base station does not know that UE needs to receive D2D service data and still allocates resources to UE to receive and transmit cellular network unicast data on two bands, consequently UE simultaneously receives/transmit cellular network unicast data and ProSe data on the same band, a very great interference is caused therebetween and UE cannot correctly receive and transmit data. Besides, since different UE are different in receiver performance, even though UE supports transmission on two bands, due to an influence between two receiving units, simultaneous receiving on any two bands is not always feasible. If two unsuitable bands are allocated to UE to simultaneously receive two types of different service data, the interference therebetween may be very great and even UE cannot work. Therefore, in order to reasonably and effectively allocate resources to UE, the base station needs to comprehensively know whether UE has a ProSe supporting capability. By adopting the method illustrated in FIG. 1, by reporting the proximity service supporting capability through the first communication node, the second communication node can know that the first communication node has the ProSe supporting capability. Thereby, the problem that a base station cannot know whether UE has the ProSe supporting capability in the related art is solved, the first communication node can realize the reporting of the ProSe supporting capability at smaller overhead, the second communication node can reasonably and effectively allocate ProSe service and/or cellular network service resources to the first communication node after capability information is acquired, and thus the interference and influence between ProSe services and cellular network services are minimized.

In an alternative implementation process, the above-mentioned first communication node may be User Equipment UE, and the above-mentioned second communication node may be a base station.

In an exemplary embodiment, the information about the proximity service supporting capability may include but not limited to at least one of the following information:

(1) indication information about supporting a proximity service;

(2) indication information about supporting proximity service receiving and/or transmitting;

(3) indication information about all bands which correspond to all indicated bands and on which receiving and/or transmitting proximity services is supported;

(4) indication information about uplink bands which correspond to all indicated bands and on which receiving and/or transmitting proximity services is supported;

(5) indication information about downlink bands which correspond to all indicated bands and on which receiving and/or transmitting proximity services is supported;

(6) indication information about all bands which correspond to specially indicated bands and on which receiving and/or transmitting proximity services is supported;

(7) indication information about uplink bands which correspond to specially indicated bands and on which receiving and/or transmitting proximity services is supported;

(8) indication information about downlink bands which correspond to specially indicated bands and on which receiving and/or transmitting proximity services is supported;

(9) indication information about a parameter combination consisting of a band parameter set of bands for cellular communication and a band parameter set of bands for proximity services, in which the cellular communication and the proximity services are supported to be performed simultaneously;

(10) band class information of bands supporting proximity services;

(11) a band parameter set of bands on which simultaneous reception of cellular communication and proximity services is supported;

(12) a band parameter set of bands on which receiving and/or transmitting proximity services is supported;

(13) indication information about having a receiver dedicated for supporting a proximity service;

(14) indication information about having a transmitter dedicated for supporting a proximity service;

(15) indication information about the number of all receiving links;

(16) indication information about the number of all transmitting links;

(17) indication information about the number of receiving links supporting proximity services;

(18) indication information about the number of transmitting links supporting proximity services;

(19) indication information about whether gaps are required when proximity services are received on indicated bands; and

(20) indication information about whether proximity services are capable of being received simultaneously or in parallel on indicated bands.

Herein, the above-mentioned proximity service comprise at least one of the following: a ProSe discovery and a ProSe communication; the uplink band is a uplink frequency configured in a system to which the first communication node is connected or in which the first communication node resides currently; the downlink band is a downlink frequency configured in a system to which the first communication node is connected or in which the first communication node resides currently; and the system comprises at least one of the following: EUTRA and UTRA.

In an exemplary embodiment, before step S102 in which the first communication node determines the indication information, the method may further include the following operation:

In step S1, the first communication node pre-configures together with the second communication node to complete a corresponding relationship between all band ranges supported by the first communication node and band index value combinations, herein in the corresponding relationship each band range respectively corresponds to a band index value.

In an exemplary embodiment, step S102 in which the first communication node determines the indication information may include one of the following steps:

In step S2, under a situation that the first communication node supports simultaneously receiving and transmitting EUTRA network data in a band range corresponding to a first index value combination and receiving and transmitting proximity service data in a band range corresponding to a second index value combination, the first communication node determines that the first index value combination and the second index value combination need to be reported to the second communication node. Herein each of the first index value combination and the second index value combination includes one or more index values, and each index value in the one or more index values is respectively carried in a band parameter information unit.

In step S3, under a situation that the first communication node does not support simultaneously receiving and transmitting EUTRA network data in a band range corresponding to a first index value combination and receiving and transmitting proximity service data in a band range corresponding to a second index value combination, the first communication node determines that the first index value combination or the second index value combination needs to be reported to the second communication node. Herein each of the first index value combination and the second index value combination includes one or more index values, and each index value in the one or more index values is respectively carried in a band parameter information unit.

In an exemplary embodiment, before step S102 in which the first communication node determines the indication information, the method may further include the following operation:

In step S4, the first communication node pre-configures together with the second communication node to complete a corresponding relationship between all proximity service band ranges supported by a receiver and/or transmitter dedicated for proximity services and band index values. Herein in the corresponding relationship each proximity service band range respectively corresponds to a band index value, and the proximity services include at least one of the following: a ProSe discovery and a ProSe communication.

In an exemplary embodiment, step S102 in which the first communication node determines the indication information may include at least one of the following steps.

In step S5, under a situation that the first communication node configures with the receiver and/or transmitter dedicated for the proximity service, the first communication node determines that indication information about having the receiver and/or transmitter dedicated for the proximity service needs to be reported to the second communication node.

In step S6, under a situation that the first communication node acquires index values corresponding to various bands from the corresponding relationship when the receiver and/or transmitter dedicated for the proximity service configured by the first communication node works at a plurality of bands, the first communication node determines that a plurality of index value combinations needs to be reported to the second communication node.

In an exemplary embodiment, step S104 in which the first communication node reports the indication information to the second communication node may include at least one of the following modes:

In mode 1, the first communication node reports the indication information to the second communication node after receiving a request message (e.g., UECapabilityEnquiry) from the second communication node, herein the request message is used for acquiring the information about the proximity service supporting capability.

In mode 2, the first communication node actively reports the indication information to the second communication node.

FIG. 2 illustrates a flowchart of a method for processing information about a proximity service supporting capability according to one embodiment of the present document. As illustrated in FIG. 2, the method may include the following processing steps.

In step S202, a second communication node receives indication information reported by a first communication node, herein the indication information is used for indicating information about a proximity service supporting capability of the first communication node.

In step S204, the second communication node allocates a proximity service resource and/or a cellular network service resource to the first communication node according to the indication information.

In an exemplary embodiment, the above-mentioned information about the proximity service supporting capability may include but not limited to at least one of the following:

(1) indication information about supporting a proximity service;

(2) indication information about supporting proximity service receiving and/or transmitting;

(3) indication information about all bands which correspond to all indicated bands and on which receiving and/or transmitting proximity services is supported;

(4) indication information about uplink bands which correspond to all indicated bands and on which receiving and/or transmitting proximity services is supported;

(5) indication information about downlink bands which correspond to all indicated bands and on which receiving and/or transmitting proximity services is supported;

(6) indication information about all bands which correspond to specially indicated bands and on which receiving and/or transmitting proximity services is supported;

(7) indication information about uplink bands which correspond to specially indicated bands and on which receiving and/or transmitting proximity services is supported;

(8) indication information about downlink bands which correspond to specially indicated bands and on which receiving and/or transmitting proximity services is supported;

(9) indication information about a parameter combination consisting of a band parameter set of bands for cellular communication and a band parameter set of bands for proximity services, in which the cellular communication and the proximity services are supported to be performed simultaneously;

(10) band class information of bands supporting proximity services;

(11) a band parameter set of bands on which simultaneous reception of cellular communication and proximity services is supported;

(12) a band parameter set of bands on which receiving and/or transmitting proximity services is supported;

(13) indication information about having a receiver dedicated for supporting a proximity service;

(14) indication information about having a transmitter dedicated for supporting a proximity service;

(15) indication information about the number of all receiving links;

(16) indication information about the number of all transmitting links;

(17) indication information about the number of receiving links supporting proximity services;

(18) indication information about the number of transmitting links supporting proximity services;

(19) indication information about whether gaps are required when proximity services are received on indicated bands; and

(20) indication information about whether proximity services are capable of being received simultaneously or in parallel on indicated bands.

Herein, the above-mentioned proximity service comprise at least one of the following: a ProSe discovery and a ProSe communication; the uplink band is a uplink frequency configured in a system to which the first communication node is connected or in which the first communication node resides currently; the downlink band is a downlink frequency configured in a system to which the first communication node is connected or in which the first communication node resides currently; and the system comprises at least one of the following: EUTRA and UTRA.

In an exemplary embodiment, step S204 in which the second communication node allocates the proximity service resource and/or the cellular network service resource to the first communication node according to the indication information may include the following operations.

In step S7, the second communication node determines that the first communication node has the proximity service supporting capability but does not support receiving and transmitting service data simultaneously in a plurality of band ranges according to the indication information.

In step S8, the second communication node allocates the proximity service resource and the cellular network service resource to the first communication node through a time-division multiplexing mode. Or the second communication node allocates a ProSe discovery resource and the cellular network service resource to the first communication node only through the time-division multiplexing mode.

In an alternative implementation mode, frequency-division multiplexing represents that different band resources are allocated for two types of services. Time-division multiplexing represents that different time resources are allocated for two types of services.

In an exemplary embodiment, step S204 in which the second communication node allocates the proximity service resource and/or the cellular network service resource to the first communication node according to the indication information may include the following steps.

In step S9, the second communication node determines that the first communication node has the proximity service supporting capability and supports simultaneously receiving and transmitting service data in a plurality of band ranges according to the indication information.

In step S10, the second communication node allocates the proximity service resource and the cellular network service resource to the first communication node through a time-division multiplexing mode. Or the second communication node allocates the proximity service resource and the cellular network service resource to the first communication node through a frequency-division multiplexing mode. Or the second communication node allocates a ProSe discovery resource and the cellular network service resource to the first communication node through the time-division multiplexing mode and allocates a ProSe communication resource and the cellular network service resource to the first communication node through the frequency-division multiplexing mode.

In an exemplary embodiment, step S202 in which the second communication node receives the indication information reported by the first communication node may include one of the following modes.

In mode 1, after the second communication node transmits a request message to the first communication node, the second communication node receives the indication information reported by the first communication node, herein the request message is used for acquiring the information about the proximity service supporting capability.

In mode 2, the second communication node receives the indication information actively reported by the first communication node.

In current communication protocols, band index numbers are designated for all uplink and downlink bands possibly supported by UE, and each band index number, e.g., band 1, corresponds to an uplink band resource, e.g., 1920 MHz-1980 MHz, and a downlink band resource, e.g., 2110 MHz-2170 MHz. If the UE reports the band index number to the base station, it represents that a transmitter of the UE supports transmitting data on the uplink band resource corresponding to the band index number and a receiver of the UE supports receiving data on the downlink band resource corresponding to the band index number. For an FDD system, the uplink band and the downlink band are different. In other words, bands on which UE supports transmitting and supports receiving are different, too.

However, for UE supporting ProSe, it needs to notify a base station about bands on which it can not only support receiving data but also support transmitting data. However, the existing indication method obviously cannot implement such operation.

It shall be illustrated that ProSe services mentioned in the embodiment of the present document may include but not limited to at least one of the following:

(1) ProSe discovery service; and

(2) ProSe communication service.

The above-mentioned alternative implementation processes will be further described below in combination with the following alternative embodiments.

### Alternative Embodiment One

In this alternative embodiment, Table 1 is a table of a corresponding relationship between uplink and downlink band ranges and band indexes preconfigured in a system according to the alternative embodiment of the present document, as shown in Table 1:

TABLE 1

| | UL operating band | DL operating band | |
|---|---|---|---|
| E-UTRA | BS receive | BS transmit | |
| operating | UE transmit | UE receive | Duplex |
| band | FUL_LOW-FUL_high | FDL_low-FDL_high | mode |
| 1 | 1920 MHz-1980 MHz | 2110 MHz-2170 MHz | FDD |
| . . . | | | |

The method may include the following processing steps:

In step 1, a base station transmits indication information to UE, herein the indication information, e.g., UECapabilityEnquiry, is used for requesting to acquire a UE capability.

In step 2, the UE reports the indication information about the UE capability to the base station.

Herein, the indication information about the UE capability may include but not limited to at least one of the following:

(1) indication information about bands supported by UE, i.e., supportedBandCombination;

(2) ProSe-enabled flag of ProSe function supported by UE,

| | |
|---|---|
| RF-Parameters-v1020::= | SEQUENCE { |
| supportedBandCombination-r10 | SupportedBandCombination-r10 |

}

| | |
|---|---|
| RF-Parameters-xxx::= | SEQUENCE { |

| | | |
|---|---|---|
| ProSe-enabled | ENUMERATED {supported} | OPTIONAL, |

...
}

The above-mentioned ProSe-enabled may have other names, which, however, need to indicate that the UE has a ProSe discovery and/or communication capability on supported bands.

The above-mentioned SupportedBandCombination information may include but not limited to a sequence consisting of a plurality of combinations, herein each combination consists of one or more band parameters and the band parameters include band index numbers.

In step 3, after the base station receives the indication information about the UE capability and subsequently receives a D2D discovery or communication request allocation indication of the UE, the base station allocates cellular network service and/or ProSe service resources to the UE.

In this alternative embodiment, after the base station receives the SupportedBandCombination information in the indication information about the UE capability, the base station can know a band range supported by the UE according to the preconfigured table of the corresponding relationship between uplink and downlink band ranges and band indexes. If each of partial combinations in the sequence has a plurality of band parameters, it indicates that the UE supports simultaneously receiving and transmitting data on uplink and downlink bands corresponding to the plurality of bands. And if each of all combinations in the sequence only has one band parameter, it indicates that the UE does not support simultaneously receiving and transmitting data on a plurality of bands.

After the base station receives the ProSe-enabled indication information, if the base station knows that the UE has the ProSe discovery and/or communication supporting capability, there are service data which need to be transmitted and the UE does not support simultaneously receiving/transmitting data on a plurality of bands, the base station may adopt one of the following operations.

In operation 1, a ProSe discovery and/or communication service resource and a cellular network service resource are allocated to the UE through a time-division multiplexing mode.

In operation 2, a ProSe discovery service resource and a cellular network service resource are allocated to the UE through a time-division multiplexing mode. However, a ProSe communication service resource and a cellular network service resource cannot be allocated to the UE through a time-division multiplexing mode.

Herein, the ProSe discovery service and/or communication service resource may include resources for UE to transmit data and resources for UE to monitor data.

### Alternative Embodiment Two

In this alternative embodiment, if UE supports simultaneously receiving and transmitting data on N bands, where N is a positive integer and N≧2, this alternative embodiment has the following difference from alternative embodiment 1:

After the base station receives the ProSe-enabled indication information, if the base station knows that the UE has the ProSe discovery and/or communication supporting capability and there are service data which need to be transmitted, the base station may adopt one of the following operations.

In operation 1, a ProSe discovery and/or communication service resource and a cellular network service resource are allocated to the UE through a time-division multiplexing mode.

In operation 2, a ProSe discovery and/or communication service resource and a cellular network service resource are allocated to the UE through a frequency-division multiplexing mode.

The base station may at most allocate N-M bands to the UE to receive/transmit cellular network service data and allocate M bands to the UE to receive ProSe discovery and/or communication service data, where M=1:N, i.e., M is a natural number greater than or equal to 1 and smaller than or equal to N, herein a preferred value of M is 1. In an alternative implementation process, when M=N, it indicates that the UE only receives cellular network control information and ProSe discovery and/or communication service data and does not receive cellular network service data.

In operation 3, a ProSe discovery service resource and a cellular network service resource are allocated to the UE through a time-division multiplexing mode, and a ProSe communication service resource and a cellular network service resource are allocated to the UE through a frequency-division multiplexing mode.

The base station may at most simultaneously allocate N-M bands to the UE to receive cellular network service data and allocate M bands to the UE to receive ProSe communication service data, where M=1:N, herein a preferred value of M is 1. In an alternative implementation process, when M=N, it indicates that the UE only receives cellular network control information and ProSe communication service data and does not receive cellular network service data.

In this alternative embodiment, the base station preferentially selects to execute operation 3. For example, if N=2, it indicates that the UE supports simultaneous receiving and transmitting on two bands. If there are no ProSe service data which need to be transmitted, the carrier aggregation capability of the UE is 2, i.e., cellular network data may be simultaneously received and transmitted on two bands. However, when the UE starts transmitting ProSe communication service data, the UE can only receive and transmit cellular network data on one band, i.e., for a cellular network, the carrier aggregation capability of the UE is decreased to 1.

### Alternative Embodiment Three

This alternative embodiment has the following difference from alternative embodiment 1 and alternative embodiment 2: the UE separately indicates a ProSe discovery capability and a ProSe communication capability.

A terminal reports UE capability information to a base station, herein the UE capability information may include but not limited to at least one of the following:

(1) ProSe-discovery-enabled flag; and
(2) ProSe-communication-enabled flag.

| | |
|---|---|
| RF-Parameters-xxx::= | SEQUENCE { |
| ProSe-discovery-enabled | ENUMERATED {supported} OPTIONAL, |

| | |
|---|---|
| ProSe-communication-enabled | ENUMERATED {supported} |

OPTIONAL,
...
}

ProSe-discovery-enabled identification and ProSe-communication-enabled identification may adopt other names, which, however, need to respectively indicate that the UE has ProSe discovery and ProSe communication capabilities on bands supported thereby.

After the base station receives the ProSe-discovery-enabled indication information, if the base station knows that the UE has the ProSe discovery supporting capability, there are service data which need to be transmitted and the UE does not support simultaneously receiving/transmitting data on a plurality of bands, the base station may adopt the following operation: a ProSe discovery resource and a cellular network service resource are allocated to the UE through a time-division multiplexing mode.

After the base station receives the ProSe-communication-enabled indication information, if the base station knows that the UE has the ProSe communication supporting capability, there are service data which need to be transmitted and the UE does not support simultaneously receiving/transmitting data on a plurality of bands, the base station may adopt the following operation: a ProSe communication resource and a cellular network service resource are allocated to the UE through a time-division multiplexing mode.

Herein, the ProSe discovery service and/or communication service resource may include but not limited to resources for UE to transmit data and resources for UE to monitor data.

### Alternative Embodiment Four

In this alternative embodiment, UE has a capability of supporting simultaneously receiving and transmitting data on N bands. In addition to that specific parameter values of capability information reported by the UE are different, this alternative embodiment further has the following difference from preferred embodiment 3.

After the base station receives the ProSe-discovery-enabled identification and/or the ProSe-communication-enabled identification, in addition to all operations mentioned in alternative embodiment 3, the base station may also adopt at least one of the following operations.

In operation 1, a ProSe discovery and/or communication service resource and a cellular network service resource are allocated to the UE through a frequency-division multiplexing mode.

The base station may at most allocate N-M bands to the UE to receive cellular network service data and allocate M bands to the UE to receive ProSe discovery and/or communication service data, where M=1:N, herein a preferred value of M is 1. When M=N, it indicates that the UE only receives cellular network control information and ProSe discovery and/or communication service data and does not receive cellular network service data.

In operation 2, a ProSe discovery service resource and a cellular network service resource are allocated to the UE through a time-division multiplexing mode, and a ProSe communication service resource and a cellular network service resource are allocated to the UE through a frequency-division multiplexing mode.

The base station may at most simultaneously allocate N-M bands to the UE to receive cellular network service data and allocate M bands to the UE to receive ProSe communication service data, where M=1:N, herein a preferred value of M is 1. When M=N, it indicates that the UE only receives cellular network control information and ProSe communication service data and does not receive cellular network service data.

### Alternative Embodiment Five

This alternative embodiment has the following difference from alternative embodiment 1:

A terminal reports UE capability information to a base station, herein the UE capability information may include but not limited to at least one of the following: ProSe-discovery-enabled identification and ProSe-communication-enabled identification.

| RF-Parameters-xxx::= | SEQUENCE { | |
|---|---|---|
| ProSe-discovery-enabled::= | SEQUENCE { | |
| ProSe-receiver | ENUMERATED {supported} | OPTIONAL,}, |

| | |
|---|---|
| ProSe-communication-enabled::= | SEQUENCE { |

| | | |
|---|---|---|
| ProSe-receiver | ENUMERATED {supported} | OPTIONAL,} |

...
}

ProSe-discovery-enabled identification and ProSe-communication-enabled identification may adopt other names, which, however, need to respectively indicate that the UE has ProSe discovery and ProSe communication capabilities. ProSe-receiver identification may also adopt other names to indicate whether the UE supports receiving ProSe service data by adopting a special receiver.

If the UE supports receiving ProSe service data by adopting a separate receiver, the UE may simultaneously receive cellular network service and ProSe service data, and the base station does not need to consider about time-division processing for ProSe services when downlink cellular network resources are allocated to the UE.

Herein, the ProSe discovery service and/or communication service resource may include but not limited to resources for UE to transmit data and resources for UE to monitor data.

### Alternative Embodiment Six

In this alternative embodiment, if UE supports receiving ProSe service data by adopting a separate receiver, this alternative embodiment has the following difference from alternative embodiment 5:

In addition to the table of the corresponding relationship mentioned in alternative embodiment 1, a table of a corresponding relationship between ProSe service working band ranges and band indexes further needs to be preconfigured to the base station and the UE, as shown in Table 2:

TABLE 2

| | Operating band |
|---|---|
| | UE receive |
| | UE transmit |
| ProSe operating band | Flow-Fhigh |
| 1 | F1 MHz-F2 MHz |
| . . . | |

In addition, the UE further needs to report band indexes corresponding to working band ranges supporting ProSe services. After the base station receives the index information, the base station may allocate a ProSe service resource to the UE on a band corresponding to the band index.

### Alternative Embodiment Seven

This alternative embodiment has the following difference from alternative embodiment 1:

ProSe-enabled identification mentioned in alternative embodiment 1 is refined and may include but not limited to the following cases. ProSe-UL-enabled and ProSe-DL-enabled, herein ProSe-UL-enabled indicates that UE supports receiving and transmitting ProSe service data on uplink bands corresponding to reported and supported band indexes; and ProSe-DL-enabled indicates that UE supports receiving and transmitting ProSe service data on downlink bands corresponding to reported and supported band indexes. If the UE simultaneously reports ProSe-UL-enabled identification and ProSe-DL-enabled identification, it indicates that the UE may support receiving and transmitting ProSe service data on uplink and downlink bands corresponding to reported band indexes.

After the base station receives the ProSe-enabled identification, a processing mode is the same as that in alternative embodiment 1, i.e., a ProSe service resource is allocated to the UE on bands supported by the UE.

| | |
|---|---|
| RF-Parameters-v1020::= | SEQUENCE { |

| | |
|---|---|
| supportedBandCombination-r10 | SupportedBandCombination-r10 |

}

| RF-Parameters-xxx::= | SEQUENCE { | |
|---|---|---|
| ProSe-UL-enabled | ENUMERATED {supported} | OPTIONAL, |
| ProSe-DL-enabled | ENUMERATED {supported} | OPTIONAL, |

...
}

### Alternative Embodiment Eight

This alternative embodiment continuously performs refining on the basis of alternative embodiment 1 and has the following difference:

Bands, corresponding to band indexes, on which UE supports ProSe services, are specifically indicated. A base station and a terminal pre-configure a table of a corresponding relationship between uplink and downlink band ranges and band indexes, as shown in Table 1. The terminal reports UE capability information to the base station, herein the UE capability information may include but not limited to: indication information about band indexes corresponding to bands on which UE supports working on a cellular network.

If the UE supports receiving and transmitting cellular network data on a plurality of bands but can only support receiving and transmitting ProSe service data on uplink bands and/or downlink bands corresponding to partial band indexes, it needs to respectively indicate bands, on corresponding uplink bands and/or downlink bands of which receiving and transmitting are supported.

UE reports indication information about band parameters, and the indication information may include: band index numbers and indication information UL-ProSe and/or DL-ProSe about whether uplink frequencies and/or downlink frequencies corresponding to band index numbers support receiving and transmitting ProSe service data.

BandParameters-xxx::=SEQUENCE {

| | |
|---|---|
| bandEUTRA-xxx | FreqBandIndicator, |

| | | |
|---|---|---|
| UL-ProSe | ENUMERATD {supported} | OPTIONAL, |
| DL-ProSe | ENUMERATD {supported} | OPTIONAL, |

}

UL-ProSe represents that ProSe discovery and/or communication service data are capable of being received and transmitted on an uplink band corresponding to a band index.

DL-ProSe represents that ProSe discovery and/or communication service data are capable of being received and transmitted on a downlink band corresponding to a band index.

After the base station receives the above-mentioned indication information, the base station can know whether the UE has a capability of supporting ProSe discovery and/or communication, and bands on which ProSe discovery and/or communication are supported. A resource allocation mode thereof is similar to that in alternative embodiment 1 and thus is not repetitively described here.

### Alternative Embodiment Nine

This alternative embodiment has the following difference from alternative embodiment 8:

UE reports indication information about band parameters, and the indication information may include: a band index number and a class of a band. The class of the band may be used for judging whether the band supports ProSe services. For example, a class above h indicates that the band supports ProSe services. Otherwise, it indicates that the band does not support ProSe services.

### Preferred Embodiment Ten

In step 1, a base station transmits indication information to UE, herein the indication information, e.g., UECapabilityEnquiry, is used for requesting to acquire a UE capability.

In step 2, the UE reports indication information about the UE capability to the base station.

Herein, the indication information about the UE capability may include but not limited to:

(1) a band parameter information combination corresponding to bands on which UE supports cellular communication and a band parameter information combination corresponding to bands on which UE supports proximity services, e.g., BandCombination and ProSeBandCombination, which do not exclude other names.

(2) one or more band parameter combinations corresponding to bands on which UE supports simultaneously receiving cellular service data and proximity service data, herein band parameters include band indexes, and UE receives cellular service data on downlink bands corresponding to FDD band indexes and receives proximity service data on downlink bands corresponding to FDD band indexes. Herein, each band parameter combination may consist of one or more band parameters. If a band parameter combination includes a plurality of band parameters, it indicates that UE can support simultaneously receiving cellular service data and proximity service data on a plurality of bands.

In step 3, after the base station receives the indication information about the UE capability and subsequently receives a D2D discovery or communication request allocation indication of the UE, the base station allocates a cellular network service and/or ProSe service resource to the UE.

The base station may determine bands on which the UE can receive cellular communication data and bands on which the UE can receive proximity service data, so as to allocate suitable service resources to the UE.

### Alternative Embodiment Eleven

This alternative embodiment has the following difference from alternative embodiment 8: UL-ProSe is further divided into UL-ProSe-discovery and UL-ProSe-communication, and DL-ProSe is further divided into DL-ProSe-discovery and DL-ProSe-communication.

UL-ProSe-discovery represents that ProSe discovery service data are capable of being received and transmitted on an uplink band corresponding to a band index.

DL-ProSe-discovery represents that ProSe discovery service data are capable of being received and transmitted on a downlink band corresponding to a band index.

UL-ProSe-communication represents that ProSe communication service data are capable of being received and transmitted on an uplink band corresponding to a band index.

DL-ProSe-communication represents that ProSe communication service data are capable of being received and transmitted on a downlink band corresponding to a band index.

After the base station knows the information about the UE capability, a processing method thereof is similar to that in alternative embodiment 1 and thus is not repetitively described here.

### Alternative Embodiment Twelve

This alternative embodiment has the following difference from alternative embodiment 1:

A base station and a terminal also need to pre-configure a table of a corresponding relationship between uplink and downlink band ranges for cellular communication and band indexes, as shown in Table 1. Simultaneously, the base station and the terminal further need to pre-configure a table of a corresponding relationship between bands for ProSe discovery and/or communication services and band indexes, as illustrated in Table 3:

TABLE 3

| | ProSe operating band |
|---|---|
| | UE transmit |
| | UE receive |
| ProSe service operating band | Flow-Fhigh |
| T | F11 MHz-F12 MHz |
| T + 1 | F13 MHz-F14 MHz |
| . . . | |

It needs to be stated that index numbers in Table 3 are not repeated with index numbers in Table 1.

UE reports band index numbers corresponding to bands which support ProSe services and band index numbers corresponding to bands which support cellular services. If the UE supports simultaneously receiving and transmitting cellular service data and ProSe discovery and/or communication service data, band index numbers for different services are reported in a combined manner. For example, if the UE simultaneously supports cellular communication on band 1 and ProSe discovery and/or communication on band 50, the UE reports a combination {1, 50} through bandParameterList indication information. The UE needs to report all possible combinations in bandParameterList.

The base station can search in the table according to band index numbers to know bands on which the UE supports simultaneously transmitting cellular communication service data and ProSe discovery and/or communication service data.

### Alternative Embodiment Thirteen

This alternative embodiment has the following difference from alternative embodiment 12:

Since index numbers in Table 3 are not repeated with index numbers in Table 1, the same indication information cannot be shared to indicate bands in Table 1 and Table 3, and different indication information needs to be respectively used to indicate indexes thereof

SupportedBandCombination-r10::=SEQUENCE (SIZE

(1..maxBandComb-r10)) OF BandCombinationParameters-r10

| BandCombinationParameters-xxx::=SEQUENCE { | |
|---|---|
| bandParameterList-xxx | SEQUENCE (SIZE |
| (1..maxSimultaneousBands-r10)) OF BandParametersProSe | |
| EUTRA-xxx OPTIONAL, | |
| ... | |
| } | |
| BandParametersProSe EUTRA-xxx::=SEQUENCE { | |
| bandEUTRA-xxx | BandParameters-xxx |
| OPTIONAL, | |
| bandProSe-xxx | BandParametersProSe-xxx |

OPTIONAL,
...
}

Herein, bandParameterList indication information indicates a combination of band indexes corresponding to a plurality of bands on which UE can simultaneously work, and this combination may include one or more bandEUTRA and/or bandProSe. BandEUTRA indication information indicates band index numbers corresponding to bands on which UE support cellular services. And bandProSe indication information indicates band index numbers corresponding to bands on which UE supports ProSe services.

### Alternative Embodiment Fourteen

In this alternative embodiment, a special receiver/transmitter for ProSe services may be designed for certain UE. UE needs to report indication information to a base station to notify the base station about whether the UE has a special receiver/transmitter for ProSe services.

Therefore, this alternative embodiment further has the following difference from alternative embodiment 1:

Capability indication information reported by the UE may include:

| | |
|---|---|
| RF-Parameters-xxx::= | SEQUENCE { |
| tx-ConfigProSe | ENUMERATED {supported}, OPTIONAL |
| rx-ConfigProSe | ENUMERATED {supported}, OPTIONAL |

...
}

Herein, tx-ConfigProSe represents that the UE has a special transmitter for ProSe services; and rx-ConfigProSe represents that the UE has a special receiver for ProSe services.

If the base station knows that the UE supports receiving ProSe service data by adopting a special receiver after the base station receives the rx-ConfigProSe indication information, it is not necessary to share a receiver/transmitter with a cellular network. In other words, the base station may independently allocate resources for the two types of services.

### Alternative Embodiment Fifteen

This alternative embodiment has the following difference from specific embodiment 14: in consideration of that bands on which the special receiver/transmitter for ProSe services works are different from bands on which the special receiver/transmitter for cellular network services works, band ranges supported by the special receiver/transmitter for ProSe services needs to be additionally indicated.

A base station side and a UE side both need to pre-configure a table of a corresponding relationship between special band ranges for ProSe services and band indexes.

Capability indication information reported by UE may include:

SupportedProSeBandCombination-xxx::=SEQUENCE (SIZE (1 . . . maxBandComb-r10)) OF ProSeBandCombinationParameter-r10

| | |
|---|---|
| ProSeBandCombinationParameters-xxx::= | SEQUENCE { |
| ProSeBandParameterList-xxx | SEQUENCE (SIZE |

(1...maxSimulatneousBands-r10)) OF ProSeBandParameters OPTIONAL,
...
}

| | |
|---|---|
| ProSebandEUTRA-xxx | ProSeFreqBandIndicator-xxx |

OPTIONAL,
...
}

All above-mentioned indication information may adopt other names and meanings represented thereby are as follows.

Herein, SupportedProSeBandCombination may include but not limited to a sequence consisting of a plurality of combinations, herein each combination consists of band index numbers corresponding to one or more ProSe working bands and represents that UE can simultaneously receive and transmit ProSe service data on bands indicated by this combination.

After the base station receives the above-mentioned SupportedProSeBandCombination, the base station can know ranges of bands on which the UE supports simultaneously receiving and transmitting ProSe service data according to the table of the preconfigured corresponding relationship between uplink and downlink band ranges and band indexes. If each of partial combinations in the sequence has a plurality of band index numbers, it indicates that the UE supports simultaneously receiving and transmitting ProSe service data on bands corresponding to a plurality of bands. And if each of all combinations in the sequence has one band number, it indicates that the UE does not support receiving and transmitting ProSe service data on a plurality of bands simultaneously. After the base station acquire the above-mentioned information, the base station can reasonably allocate ProSe service data transmitting resources to the UE.

Similarly, since ProSe service may include but not limited to: ProSe discovery and ProSe communication, therefore, all above-mentioned ProSe related indications may be used for respectively indicating ProSe discovery and ProSe communication.

### Alternative Embodiment Sixteen

In step 1, a base station transmits indication information to UE, herein the indication information, e.g., UECapabilityEnquiry, is used for requesting to acquire a UE capability.

In step 2, the UE reports, to the base station, band parameters of all FDD bands which can support receiving and band combination parameter information of bands which can support simultaneous or parallel receiving, herein the band combination information includes parameter information of each band in a combination, and each band parameter includes at least one of the following:

indication information about whether ProSe service data receiving is supported;

indication information about whether gaps are needed for receiving ProSe service data on a band;

| for example: | |
|---|---|
| BandInfoEUTRA-x::= | SEQUENCE { |
| ProSeReceptionNeedForGaps | BOOLEAN |

...
}

indication information about whether receiving ProSe service data on a band simultaneously or in parallel is supported;

| for example: | |
|---|---|
| BandInfoEUTRA-x::= | SEQUENCE { |
| SimultaneousReceptionProSe | BOOLEAN |

...
}

In step 3, after the base station receives the indication information about the UE capability, the base station may make the following judgment.

If the UE indicates, in parameters of a band, e.g., band 1, of a certain band combination, e.g., band 1 and band 2, that gaps are needed for receiving ProSe service data on the same band, or indicates that data cannot be received simultaneously or in parallel, it indicates that the UE can receive data simultaneously or in parallel on band 1 and band 2, can receive proximity service data on band 1, but cannot receive proximity service data and cellular service data simultaneously or in parallel on band 1.

If the UE indicates, in parameters of a band, e.g., band 3, of a certain band combination, e.g., band 3 and band 4, that gaps are not needed for receiving ProSe service data on the same band, or indicates that data can be received simultaneously or in parallel, it indicates that the UE can receive data simultaneously or in parallel on band 3 and band 4, and can receive proximity service data and cellular service data simultaneously or in parallel on band 3, e.g., receive proximity service data on an uplink band corresponding to band 3 and receive cellular service data on a downlink band corresponding to band 3.

If the UE indicates, in parameters of a certain band, e.g., band 5, that gaps are not needed for receiving ProSe service data on the same band, or indicates that data can be received simultaneously or in parallel, it indicates that the UE can receive proximity service data and cellular service data simultaneously or in parallel on band 5, e.g., receive proximity service data on an uplink band corresponding to band 5 and receive cellular service data on a downlink band corresponding to band 5.

If the UE indicates, in parameters of a certain band, e.g., band 6, that gaps are needed for receiving ProSe service data on the same band, or indicates that data cannot be received simultaneously or in parallel, it indicates that the UE cannot receive proximity service data and cellular service data simultaneously or in parallel on band 6.

According to the above-mentioned information, the base station may determine bands on which the UE can receive cellular communication data simultaneously or in parallel, bands on which the UE can receive proximity service data simultaneously or in parallel, and bands on which the UE can receive cellular communication and proximity service data simultaneously or in parallel. After the base station subsequently receive a D2D discovery or communication request allocation indication of the UE, the base station may allocate suitable service resources to the UE.

### Alternative Embodiment Seventeen

In step 1, a base station transmits indication information to UE, herein the indication information, e.g., UECapabilityEnquiry, is used for requesting to acquire a UE capability.

In step 2, the UE reports, to the base station, band parameters of all FDD bands which can support receiving and band combination parameter information of bands which can support simultaneous or parallel receiving, herein each band parameter and/or band set includes at least one of the following:

1) indication information about whether ProSe service data receiving is supported;

2) indication information about whether gaps are needed for receiving ProSe service data on each band in a proximity service band list ProSeBandList;

for example:

| | |
|---|---|
| ProSeBandList::= | SEQUENCE (SIZE (1..maxBands)) |
| | OF ProSeBandInfo |
| ProSeBandInfo::= | SEQUENCE { |

| | |
|---|---|
| ProSeReceptionNeedForGaps | BOOLEAN |

}

3) indication information about whether ProSe service data on each band can be received simultaneously and in parallel in a proximity service band list ProSeBandList;

for example:

| | |
|---|---|
| ProSeBandList::= | SEQUENCE (SIZE (1..maxBands)) |
| | OF ProSeBandInfo |
| ProSeBandInfo::= | SEQUENCE { |

| | |
|---|---|
| SimultaneousReceptionProSe | ENUMERATED {supported} |

}

4) indication information about whether gaps are needed for receiving ProSe service data on each band in a proximity service inter-frequency band list ProSeinterFreqBandList, e.g., ProSeFreqNeedForGaps;

| for example: | |
|---|---|
| ProSeinterFreqBandList::= | SEQUENCE (SIZE (1..maxBands)) |

OF ProSeinterFreqBandInfo

| | |
|---|---|
| ProSeInterFreqBandInfo::= | SEQUENCE { |

| | |
|---|---|
| ProSeinterFreqNeedForGaps | BOOLEAN |

}

5) indication information about whether gaps are needed for receiving ProSe service data on each band in a proximity service inter-RAT band list ProSeinterRAT-BandList.

In step 3, after the base station receives the indication information about the UE capability, the base station may make the following judgment.

If the UE indicates, in a proximity service band list or a proximity service inter-frequency band list or a proximity service inter-RAT band list of parameters of a certain band, e.g., band 1, that gaps are not needed on a certain corresponding band, e.g., band 1, or indicates, in a proximity service band list, that data can be received simultaneously or in parallel on a certain corresponding band, e.g., band 1, it indicates that the UE can receive proximity service data and cellular service data simultaneously or in parallel on band 1, e.g., receive proximity service data on an uplink band corresponding to band 1 and receive cellular service data on a downlink band corresponding to band 1. Otherwise, it indicates that the UE cannot receive proximity service data and cellular service data simultaneously or in parallel on band 1.

If the UE indicates, in a proximity service band list or a proximity service inter-frequency band list or a proximity service inter-RAT band list of parameters of a certain band, e.g., band 2, that gaps are not needed on a certain corresponding band, e.g., band 1, or indicates, in a proximity service band list, that data can be received simultaneously or in parallel on a certain corresponding band, e.g., band 1, it indicates that the UE can receive proximity service data and cellular service data simultaneously or in parallel on band 1 and band 2. Otherwise, it indicates that the UE cannot receive proximity service data and cellular service data simultaneously or in parallel on band 1 and band 2.

Similarly, if the UE indicates, in a proximity service band list or a proximity service inter-frequency band list or a proximity service inter-RAT band list of parameters of a certain band set, e.g., band 1 and band 2, that gaps are not needed on a certain corresponding band, e.g., band 1, or indicates, in a proximity service band list, that data can be received simultaneously or in parallel on a certain corresponding band, e.g., band 1, it indicates that the UE can receive cellular service data simultaneously or in parallel on band 1 and band 2, and can receive proximity service data and cellular service data simultaneously or in parallel on band 1, e.g., receive proximity service data on an uplink band corresponding to band 1 and receive cellular service data on a downlink band corresponding to band 1. Otherwise, it indicates that the UE cannot receive proximity service data and cellular service data simultaneously on band 1.

According to the above-mentioned information, the base station may determine bands on which the UE can receive cellular communication data simultaneously, bands on which the UE can receive proximity service data simultaneously, and bands on which the UE can receive cellular communication and proximity service data simultaneously. After the base station subsequently receive a D2D discovery or communication request allocation indication of the UE, the base station may allocate suitable service resources to the UE.

### Alternative Embodiment Eighteen

In step 1, a base station transmits indication information to UE, herein the indication information, e.g., UECapabilityEnquiry, is used for requesting to acquire a UE capability.

In step 2, the UE reports, to the base station, band parameter information of bands on which proximity service data can be simultaneously received/transmitted and band parameter information of bands on which cellular service data can be simultaneously received/transmitted, which may include various combinations, herein each band parameter may include but not limited to at least one of the following:

(1) frequency information of band;

(2) indication information indicating whether a ProSe-discovery signal is received or transmitted on a band;

(3) indication information indicating whether a ProSe-communication signal is received or transmitted on a band;

An alternative information indication unit is as follow:

SupportedBandCombination-rxx::= SEQUENCE (SIZE (1..maxBandComb-rxx)) OF

BandCombinationParameters-rxx

BandCombinationParameters-rxx::= SEQUENCE (SIZE (1..maxSimultaneousBand-r10))

OF BandParameters-rxx

| BandParameters-rxx::=SEQUENCE { | |
|---|---|
| bandEUTRA-rxx | FreqBandIndicator, |

| | | |
|---|---|---|
| bandParametersUL-rxx | BandParametersUL-r10 | OPTIONAL, |
| bandParametersDL-rxx | BandParametersDL-r10 | OPTIONAL, |
| ProSe-discovery-enabled | ENUMERATED {supported} | OPTIONAL, |
| ProSe-communication-enabled | ENUMERATED {supported} | OPTIONAL, |

}

According to the above-mentioned information, the base station may determine frequencies on which the UE can receive proximity service data and frequencies on which the UE has cellular communication supporting capability, related uplink CA capability and MIMO capability and related downlink CA capability and MIMO capability while proximity service data are received on each indicated frequency, herein the CA capability and MIMO capability are indicated in the bandParametersUL-rxx and bandParametersDL-rxx.

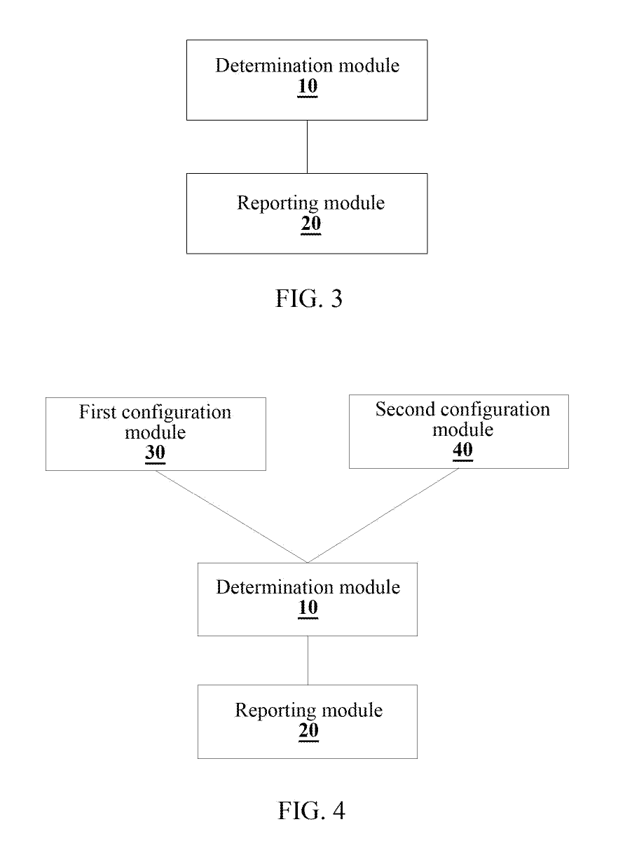

FIG. 3 illustrates a structural diagram of an apparatus for reporting information about a proximity service supporting capability according to one embodiment of the present document. As illustrated in FIG. 3, the apparatus for reporting the information about the proximity service supporting capability is arranged at a first communication node and may include the following modules. A determination module 10 is configured to determine indication information to be reported, herein the indication information is used for indicating information about a proximity service supporting capability of the first communication node. A reporting module 20 is arranged to report the indication information to a second communication node.

By adopting the apparatus illustrated in FIG. 3, the problem that a base station cannot know whether UE has the ProSe supporting capability in the related technology is solved, the first communication node can realize the reporting of the ProSe supporting capability at smaller overhead, the second communication node can reasonably and effectively allocate ProSe service and/or cellular network service resources to the first communication node after capability information is acquired, and thus the interference and influence between ProSe services and cellular network services are minimized.

In an alternative implementation process, the above-mentioned first communication node may be User Equipment UE, and the second communication node may be a base station.

In an exemplary embodiment, the information about the proximity service supporting capability may include but not limited to at least one of the following information:

(1) indication information about supporting a proximity service;

(2) indication information about supporting proximity service receiving and/or transmitting;

(3) indication information about all bands which correspond to all indicated bands and on which receiving and/or transmitting proximity services is supported;

(4) indication information about uplink bands which correspond to all indicated bands and on which receiving and/or transmitting proximity services is supported;

(5) indication information about downlink bands which correspond to all indicated bands and on which receiving and/or transmitting proximity services is supported;

(6) indication information about all bands which correspond to specially indicated bands and on which receiving and/or transmitting proximity services is supported;

(7) indication information about uplink bands which correspond to specially indicated bands and on which receiving and/or transmitting proximity services is supported;

(8) indication information about downlink bands which correspond to specially indicated bands and on which receiving and/or transmitting proximity services is supported;

(9) indication information about a parameter combination consisting of a band parameter set of bands for cellular communication and a band parameter set of bands for proximity services, in which the cellular communication and the proximity services are supported to be performed simultaneously;

(10) band class information of bands supporting proximity services;

(11) a band parameter set of bands on which simultaneous reception of cellular communication and proximity services is supported;

(12) a band parameter set of bands on which receiving and/or transmitting proximity services is supported;

(13) indication information about having a receiver dedicated for supporting a proximity service;

(14) indication information about having a transmitter dedicated for supporting a proximity service;

(15) indication information about the number of all receiving links;

(16) indication information about the number of all transmitting links;

(17) indication information about the number of receiving links supporting proximity services;

(18) indication information about the number of transmitting links supporting proximity services;

(19) indication information about whether gaps are required when proximity services are received on indicated bands; and

(20) indication information about whether proximity services are capable of being received simultaneously or in parallel on indicated bands.

Herein, the above-mentioned proximity service comprise at least one of the following: a ProSe discovery and a ProSe communication; the uplink band is a uplink frequency configured in a system to which the first communication node is connected or in which the first communication node resides currently; the downlink band is a downlink frequency configured in a system to which the first communication node is connected or in which the first communication node resides currently; and the system comprises at least one of the following: EUTRA and UTRA.

In an exemplary embodiment, as illustrated in FIG. 4, the apparatus may further include the following modules. A first configuration module 30 is arranged to pre-configure with the second communication node to complete a corresponding relationship between all band ranges supported by the first communication node and band index value combinations, herein each band range in the corresponding relationship respectively corresponds to a band index value.

In an exemplary embodiment, the determination module 10 is arranged to determine the indication information according to one of the following modes.

(1) Under a situation of simultaneously supporting receiving and transmitting EUTRA network data in a band range corresponding to a first index value combination and receiving and transmitting proximity service data in a band range corresponding to a second index value combination, it is determined that the first index value combination and the second index value combination need to be reported to the second communication node, herein each of the first index value combination and the second index value combination includes one or more index values, and each index value in the one or more index values is respectively carried in a band parameter information unit.

(2) Under a situation of not supporting simultaneously receiving and transmitting EUTRA network data in a band range corresponding to a first index value combination and receiving and transmitting proximity service data in a band range corresponding to a second index value combination, it is determined that the first index value combination or the second index value combination needs to be reported to the second communication node, herein each of the first index value combination and the second index value combination includes one or more index values, and each index value in the one or more index values is respectively carried in a band parameter information unit.

In an exemplary embodiment, as illustrated in FIG. 4, the above-mentioned apparatus may further include: a second configuration module 40 which is arranged to pre-configure with the second communication node to complete a corresponding relationship between all proximity service band ranges supported by a receiver and/or transmitter dedicated for a proximity service and band index values, herein in the corresponding relationship each proximity service band range respectively corresponds to a band index value, and the proximity service may include but not limited to at least one of the following: a ProSe discovery and a ProSe communication.

In an exemplary embodiment, the determination module 10 is arranged to determine the indication information according to one of the following modes:

(1) Under a situation of configuring with the special receiver and/or transmitter for the proximity service by itself, it is determined that indication information about having the receiver and/or transmitter dedicated for the proximity service needs to be reported to the second communication node.

(2) Under a situation of acquiring index values corresponding to various bands from the corresponding relationship when the receiver and/or transmitter dedicated for the proximity service configured by the first communication node works at a plurality of bands, it is determined that a plurality of index value combinations needs to be reported to the second communication node.

In an exemplary embodiment, the reporting module 20 is arranged to report the indication information to the second communication node according to one of the following modes.

In mode 1, the first communication node reports the indication information to the second communication node after receiving a request message from the second communication node, herein the request message is used for acquiring the information about the proximity service supporting capability.

In mode 2, the first communication node actively reports the indication information to the second communication node.

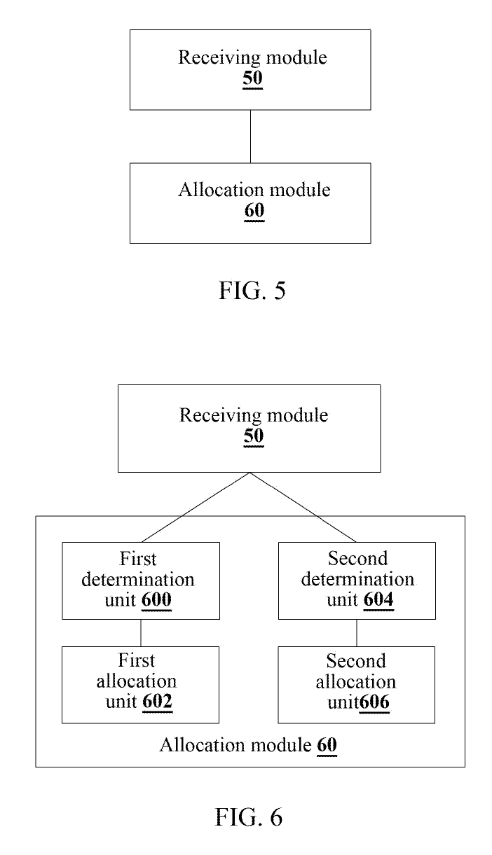

FIG. 5 illustrates a structural diagram of an apparatus for processing information about a proximity service supporting capability according to one embodiment of the present document. As illustrated in FIG. 5, the apparatus for processing the information about the proximity service supporting capability is arranged at a second communication node and may include the following modules. A receiving module 50 is arranged to receive indication information reported by a first communication node, herein the indication information is used for indicating information about a proximity service supporting capability of the first communication node. An allocation module 60 is arranged to allocate a proximity service resource and/or a cellular network service resource to the first communication node according to the indication information.

In an exemplary embodiment, the information about the proximity service supporting capability may include but not limited to at least one of the following:

(1) indication information about supporting a proximity service;

(2) indication information about supporting proximity service receiving and/or transmitting;

(3) indication information about all bands which correspond to all indicated bands and on which receiving and/or transmitting proximity services is supported;

(4) indication information about uplink bands which correspond to all indicated bands and on which receiving and/or transmitting proximity services is supported;

(5) indication information about downlink bands which correspond to all indicated bands and on which receiving and/or transmitting proximity services is supported;

(6) indication information about all bands which correspond to specially indicated bands and on which receiving and/or transmitting proximity services is supported;

(7) indication information about uplink bands which correspond to specially indicated bands and on which receiving and/or transmitting proximity services is supported;

(8) indication information about downlink bands which correspond to specially indicated bands and on which receiving and/or transmitting proximity services is supported;

(9) indication information about a parameter combination consisting of a band parameter set of bands for cellular communication and a band parameter set of bands for proximity services, in which the cellular communication and the proximity services are supported to be performed simultaneously;

(10) band class information of bands supporting proximity services;

(11) a band parameter set of bands on which simultaneous reception of cellular communication and proximity services is supported;

(12) a band parameter set of bands on which receiving and/or transmitting proximity services is supported;

(13) indication information about having a receiver dedicated for supporting a proximity service;

(14) indication information about having a transmitter dedicated for supporting a proximity service;

(15) indication information about the number of all receiving links;

(16) indication information about the number of all transmitting links;

(17) indication information about the number of receiving links supporting proximity services;

(18) indication information about the number of transmitting links supporting proximity services;

(19) indication information about whether gaps are required when proximity services are received on indicated bands; and

(20) indication information about whether proximity services are capable of being received simultaneously or in parallel on indicated bands.

Herein, the above-mentioned proximity service comprise at least one of the following: a ProSe discovery and a ProSe communication; the uplink band is a uplink frequency configured in a system to which the first communication node is connected or in which the first communication node resides currently; the downlink band is a downlink frequency configured in a system to which the first communication node is connected or in which the first communication node resides currently; and the system comprises at least one of the following: EUTRA and UTRA.

In an exemplary embodiment, as illustrated in FIG. 6, the allocation module 60 may include the following units. A first determination unit 600 is arranged to determine that the first communication node has the proximity service supporting capability but does not support receiving and transmitting service data simultaneously in a plurality of band ranges according to the indication information. A first allocation unit 602 is arranged to allocate the proximity service resource and the cellular network service resource to the first communication node through a time-division multiplexing mode. Or the second communication node allocates a ProSe discovery resource and the cellular network service resource to the first communication node only through the time-division multiplexing mode

In an exemplary embodiment, as illustrated in FIG. 6, the allocation module 60 may include the following units. A second determination unit 604 is arranged to determine that the first communication node has the proximity service supporting capability and supports simultaneously receiving and transmitting service data in a plurality of band ranges according to the indication information. A second allocation unit 606 is arranged to allocate the proximity service resource and the cellular network service resource to the first communication node through a time-division multiplexing mode. Or the second communication node allocates the proximity service resource and the cellular network service resource to the first communication node through a frequency-division multiplexing mode. Or the second communication node allocates a ProSe discovery resource and the cellular network service resource to the first communication node through the time-division multiplexing mode and allocates a ProSe communication resource and the cellular network service resource to the first communication node through the frequency-division multiplexing mode.

In an exemplary embodiment, the receiving module 50 is arranged to receive the indication information reported by the first communication node according to one of the following modes.

In mode 1, the second communication receives the indication information reported by the first communication node after transmitting a request message to the first communication node, herein the request message is used for acquiring the information about the proximity service supporting capability.

In mode 2, the second communication node receives the indication information actively reported by the first communication node.

From the description above, it can be seen that the above-mentioned embodiments realize the following technical effects (it needs to be stated that these effects are effects which can be achieved by some alternative embodiments): by adopting the technical solutions provided by the embodiments of the present document, and by reporting the proximity service supporting capability through the first communication node, the second communication node hence can know that the first communication node has the ProSe supporting capability. Thereby, the problem that a base station cannot know whether UE has the ProSe supporting capability in the related technology is solved, the first communication node can realize the reporting of the ProSe supporting capability at smaller overhead, the second communication node can reasonably and effectively allocate ProSe service and/or cellular network service resources to the first communication node after capability information is acquired, and thus the interference and influence between ProSe services and cellular network services are minimized.

Obviously, one skilled in the art should understand that all modules or all steps of the above-mentioned present document may be implemented by using general-purpose computing devices, they may be integrated in a single computing device or distributed on a network consisting of a plurality of computing devices, optionally they may be implemented by using program codes executable for computing devices, thus they may be stored in memory devices and executed by computing devices, and under certain circumstances, the illustrated or described steps may be executed according to a sequence different from the sequence here, or they may be respectively manufactured into integrated circuit modules or a plurality of modules or steps thereof may be manufactured into a single integrated circuit module to implement. Therefore, the present document is not limited to any specific combination of hardware and software.

The embodiments described above are just alternative embodiments of the present document and are not used for limiting the present document. For one skilled in the art, the present document may have various modifications and variations. Any modification, equivalent replacement, improvement and the like made within the spirit and rule of the present document shall be still included in the protection scope of the present document.

### INDUSTRIAL APPLICABILITY

As described above, the methods and apparatuses for reporting and processing the information about the proximity service supporting capability provided by the embodiments of the present document have the following beneficial effects: ProSe service and/or cellular network service resources can be reasonably and effectively allocated to the first communication node, and thus the interference and influence between ProSe services and cellular network services are minimized.

What is claimed is:

1. A method for reporting information about a proximity service supporting capability, comprising:
determining, by a first communication node, indication information to be reported, wherein the indication information is used for indicating information about a proximity service supporting capability of the first communication node; and
reporting, by the first communication node, the indication information to a second communication node.

2. The method according to claim 1, wherein the information about the proximity service supporting capability comprises at least one of the following:
indication information about bands on which a UE supports receiving and/or transmitting proximity services;
indication information about uplink bands on which a UE supports receiving and/or transmitting proximity services;
indication information about downlink bands on which a UE supports receiving and/or transmitting proximity services;
indication information about a parameter combination consisting of a band parameter set of bands for cellular communication and a band parameter set of bands for proximity services, wherein on both the bands for cellular communication and the bands for proximity services a UE supports simultaneous reception of the cellular communication and the proximity services;
band class information of bands supporting proximity services;
indication for a particular band combination of bands on which a UE supports simultaneous reception of cellular communication and proximity services;
indication information about an independent list of bands on which a UE supports receiving and/or transmitting proximity services;
indication information about having a receiver dedicated for supporting a proximity service;
indication information about having a transmitter dedicated for supporting a proximity service;
indication information about the number of all receiving links;
indication information about the number of all transmitting links;
indication information about the number of receiving links supporting proximity services;
indication information about the number of transmitting links supporting proximity services;
indication information about whether gaps are required when proximity services are received on indicated bands; and
indication information about whether proximity services are capable of being received simultaneously or in parallel on indicated bands;
wherein the proximity service comprise at least one of the following: a ProSe discovery and a ProSe communication; the uplink band is a uplink frequency configured in a system to which the first communication node is connected or in which the first communication node resides currently; the downlink band is a downlink frequency configured in a system to which the first communication node is connected or in which the first communication node resides currently; and the system comprises at least one of the following: Evolved Universal Terrestrial Radio Access, EUTRA, and Universal Terrestrial Radio Access, UTRA.

3. The method according to claim 1, wherein, before the first communication node determines the indication information, the method further comprises:
pre-configuring, by the first communication node with the second communication node, to complete a corresponding relationship between all band ranges supported by the first communication node and band index value combinations, wherein in the corresponding relationship each band range respectively corresponds to a band index value;
wherein the first communication node determining the indication information comprises one of the following:
determining, by the first communication node, that a first index value combination and a second index value combination need to be reported to the second communication node under a situation that the first communication node supports simultaneously receiving and transmitting EUTRA network data in a band range corresponding to the first index value combination and receiving and transmitting proximity service data in a band range corresponding to the second index value combination, wherein each of the first index value combination and the second index value combination comprises one or more index values, and each index value in the one or more index values is respectively carried in a band parameter information unit; and
determining, by the first communication node, that a first index value combination or a second index value combination needs to be reported to the second communication node under a situation that the first communication node does not support simultaneously receiving and transmitting EUTRA network data in a band range corresponding to the first index value combination and receiving and transmitting proximity service data in a band range corresponding to the second index value combination, wherein each of the first index value combination and the second index value combination comprises one or more index values, and each index value in the one or more index values is respectively carried in a band parameter information unit.

4. (canceled)

5. The method according to claim 1, wherein, before the first communication node determines the indication information, the method further comprises:
pre-configuring, by the first communication node with the second communication node, to complete a corresponding relationship between all proximity service band ranges supported by a receiver and/or transmitter dedicated for a proximity service and band index values, wherein in the corresponding relationship each proximity service band range respectively corresponds to a band index value, and the proximity service comprises at least one of the following: a ProSe discovery and a ProSe communication;
wherein the first communication node determining the indication information comprises at least one of the following:
determining, by the first communication node, that indication information about having the receiver and/or transmitter dedicated for the proximity service needs to be reported to the second communication node under a situation that the first communication node configures with the receiver and/or transmitter dedicated for the proximity service; and
determining, by the first communication node, that the plurality of index value combinations needs to be reported to the second communication node under a situation that the first communication node acquires index values corresponding to various bands from the corresponding relationship when the receiver and/or transmitter dedicated for the proximity service configured by the first communication node works at a plurality of bands.

6. (canceled)

7. The method according to claim 1, wherein the first communication node reporting the indication information to the second communication node comprises at least one of the following:
the first communication node reporting the indication information to the second communication node after receiving a request message from the second communication node, wherein the request message is used for acquiring the information about the proximity service supporting capability; and
the first communication node reporting actively the indication information to the second communication node.

8. The method according to claim 2, further comprising:
receiving, by a second communication node, indication information reported by a first communication node, wherein the indication information is used for indicating information about a proximity service supporting capability of the first communication node; and
allocating, by the second communication node, a proximity service resource and/or a cellular network service resource to the first communication node according to the indication information.

9. (canceled)

10. The method according to claim 98, wherein the second communication node allocating the proximity service resource and/or the cellular network service resource to the first communication node according to the indication information comprises:
the second communication node determining that the first communication node has the proximity service supporting capability but does not support receiving and transmitting service data simultaneously in a plurality of band ranges according to the indication information; and
the second communication node allocating the proximity service resource and the cellular network service resource to the first communication node through a time-division multiplexing mode; or the second communication node allocating a ProSe discovery resource and the cellular network service resource to the first communication node only through the time-division multiplexing mode.

11. The method according to claim 98, wherein the second communication node allocating the proximity service resource and/or the cellular network service resource to the first communication node according to the indication information comprises:
the second communication node determining that the first communication node has the proximity service supporting capability and supports simultaneously receiving and transmitting service data in a plurality of band ranges according to the indication information; and
the second communication node allocating the proximity service resource and the cellular network service resource to the first communication node through a time-division multiplexing mode; or the second communication node allocating the proximity service resource and the cellular network service resource to the first communication node through a frequency-division multiplexing mode; or the second communication node allocating a ProSe discovery resource and the cellular network service resource to the first communication node through the time-division multiplexing mode and allocating a ProSe communication resource and the cellular network service resource to the first communication node through the frequency-division multiplexing mode.

12. The method according to claim 8, wherein the second communication node receiving the indication information reported by the first communication node comprises one of the following:
the second communication node receiving the indication information reported by the first communication node after transmitting a request message to the first communication node, wherein the request message is used for acquiring the information about the proximity service supporting capability; and
the second communication node receiving the indication information actively reported by the first communication node.

13. An apparatus for reporting information about a proximity service supporting capability, the apparatus arranged on a first communication node, and the apparatus comprising:
a determination module, arranged to determine indication information to be reported, wherein the indication information is used for indicating information about a proximity service supporting capability of the first communication node; and
a reporting module, arranged to report the indication information to a second communication node.

14. The apparatus according to claim 13, wherein the information about the proximity service supporting capability comprises at least one of the following:
indication information about bands on which a UE supports receiving and/or transmitting proximity services;
indication information about uplink bands on which a UE supports receiving and/or transmitting proximity services;
indication information about downlink bands on which a UE supports receiving and/or transmitting proximity services;
indication information about a parameter combination consisting of a band parameter set of bands for cellular communication and a band parameter set of bands for proximity services, wherein on both the bands for cellular communication and the bands for proximity services a UE supports simultaneous reception of the cellular communication and the proximity services;
band class information of bands supporting proximity services;
indication for a particular band combination of bands on which a UE supports simultaneous reception of cellular communication and proximity services;
indication information about an independent list of bands on which a UE supports receiving and/or transmitting proximity services;
indication information about having a receiver dedicated for supporting a proximity service;
indication information about having a transmitter dedicated for supporting a proximity service;
indication information about the number of all receiving links;
indication information about the number of all transmitting links;
indication information about the number of receiving links supporting proximity services;
indication information about the number of transmitting links supporting proximity services;
indication information about whether gaps are required when proximity services are received on indicated bands; and
indication information about whether proximity services are capable of being received simultaneously or in parallel on indicated bands;
wherein the proximity service comprise at least one of the following: a ProSe discovery and a ProSe communication; the uplink band is a uplink frequency configured in a system to which the first communication node is connected or in which the first communication node resides currently; the downlink band is a downlink frequency configured in a system to which the first communication node is connected or in which the first communication node resides currently; and the system comprises at least one of the following: Evolved Universal Terrestrial Radio Access, EUTRA, and Universal Terrestrial Radio Access, UTRA.

15. The apparatus according to claim 13, wherein the apparatus further comprises:
a first configuration module, arranged to pre-configure with the second communication node to complete a corresponding relationship between all band ranges supported by the first communication node and band index value combinations, wherein in the corresponding relationship each band range respectively corresponds to a band index value;
wherein the determination module is arranged to determine the indication information according to one of the following:
determining that a first index value combination and a second index value combination need to be reported to the second communication node under a situation of simultaneously supporting receiving and transmitting EUTRA network data in a band range corresponding to the first index value combination and receiving and transmitting proximity service data in a band range corresponding to the second index value combination, wherein each of the first index value combination and the second index value combination comprises one or more index values, and each index value in the one or more index values is respectively carried in a band parameter information unit; and
determining that a first index value combination or a second index value combination needs to be reported to the second communication node under a situation of not supporting simultaneously receiving and transmitting EUTRA network data in a band range corresponding to the first index value combination and receiving and transmitting proximity service data in a band range corresponding to the second index value combination, wherein each of the first index value combination and the second index value combination comprises one or more index values, and each index value in the one or more index values is respectively carried in a band parameter information unit.

16. (canceled)

17. The apparatus according to claim 13, wherein the apparatus further comprises:
a second configuration module, arranged to pre-configure with the second communication node to complete a corresponding relationship between all proximity service band ranges supported by a receiver and/or transmitter dedicated for a proximity service and band index values, wherein in the corresponding relationship each proximity service band range respectively corresponds to a band index value, and the proximity service comprises at least one of the following: a ProSe discovery and a ProSe communication.

18. The apparatus according to claim 17, wherein the determination module is arranged to determine the indication information according to one of the following:
determining that indication information about having the receiver and/or transmitter dedicated for the proximity service needs to be reported to the second communication node under a situation of configuring with the receiver and/or transmitter dedicated for the proximity service by the first communication node; and
determining that the plurality of index value combinations needs to be reported to the second communication node under a situation of acquiring index values corresponding to various bands from the corresponding relationship when the receiver and/or transmitter dedicated for the proximity service configured by the first communication node works at a plurality of bands.

19. The apparatus according to claim 13, wherein the reporting module is arranged to report the indication information to the second communication node according to one of the following:
the first communication node reporting the indication information to the second communication node after receiving a request message from the second communication node, wherein the request message is used for acquiring the information about the proximity service supporting capability; and
the first communication node reporting actively the indication information to the second communication node.

20. An apparatus for processing information about a proximity service supporting capability, the apparatus arranged on a second communication node, and the apparatus comprising:
a receiving module, arranged to receive indication information reported by a first communication node, wherein the indication information is used for indicating information about a proximity service supporting capability of the first communication node; and
an allocation module, arranged to allocate a proximity service resource and/or a cellular network service resource to the first communication node according to the indication information.

21. The apparatus according to claim 20, wherein the information about the proximity service supporting capability comprises at least one of the following:
indication information about bands on which a UE supports receiving and/or transmitting proximity services;
indication information about uplink bands on which a UE supports receiving and/or transmitting proximity services;
indication information about downlink bands on which a UE supports receiving and/or transmitting proximity services;
indication information about a parameter combination consisting of a band parameter set of bands for cellular communication and a band parameter set of bands for proximity services, wherein on both the bands for cellular communication and the bands for proximity services a UE supports simultaneous reception of the cellular communication and the proximity services;
band class information of bands supporting proximity services;
indication for a particular band combination of bands on which a UE supports simultaneous reception of cellular communication and proximity services;
indication information about an independent list of bands on which a UE supports receiving and/or transmitting proximity services;
indication information about having a receiver dedicated for supporting a proximity service;
indication information about having a transmitter dedicated for supporting a proximity service;
indication information about the number of all receiving links;
indication information about the number of all transmitting links;
indication information about the number of receiving links supporting proximity services;
indication information about the number of transmitting links supporting proximity services;
indication information about whether gaps are required when proximity services are received on indicated bands; and
indication information about whether proximity services are capable of being received simultaneously or in parallel on indicated bands;
wherein the proximity service comprise at least one of the following: a ProSe discovery and a ProSe communication; the uplink band is a uplink frequency configured in a system to which the first communication node is connected or in which the first communication node resides currently; the downlink band is a downlink frequency configured in a system to which the first communication node is connected or in which the first communication node resides currently; and the system comprises at least one of the following: Evolved Universal Terrestrial Radio Access, EUTRA, and Universal Terrestrial Radio Access, UTRA.

22. The apparatus according to claim 21, wherein the allocation module comprises:
a first determination unit, arranged to determine that the first communication node has the proximity service supporting capability but does not support receiving and transmitting service data simultaneously in a plurality of band ranges according to the indication information; and
a first allocation unit, arranged to allocate the proximity service resource and the cellular network service resource to the first communication node through a time-division multiplexing mode; or allocate a ProSe discovery resource and the cellular network service resource to the first communication node only through the time-division multiplexing mode.

23. The apparatus according to claim 21, wherein the allocation module comprises:
a second determination unit, arranged to determine that the first communication node has the proximity service supporting capability and supports simultaneously receiving and transmitting service data in a plurality of band ranges according to the indication information; and
a second allocation unit, arranged to allocate the proximity service resource and the cellular network service resource to the first communication node through a time-division multiplexing mode; or allocate the proximity service resource and the cellular network service resource to the first communication node through a frequency-division multiplexing mode; or allocate a ProSe discovery resource and the cellular network service resource to the first communication node through the time-division multiplexing mode and allocate a ProSe communication resource and the cellular network service resource to the first communication node through the frequency-division multiplexing mode.

24. The apparatus according to claim 20, wherein the receiving module is arranged to receive the indication information reported by the first communication node according to one of the following:
the second communication node receiving the indication information reported by the first communication node after transmitting a request message to the first communication node, wherein the request message is used for acquiring the information about the proximity service supporting capability; and
the second communication node receiving the indication information actively reported by the first communication node.
